(19) United States
(12) Patent Application Publication
(10) Pub. No.: US 2022/0172567 A1
(43) Pub. Date: Jun. 2, 2022

(54) ASSESSMENT, MANAGEMENT AND STORING SYSTEM FOR THE ESTABLISHMENT OF VARIABLE WINNING OUTCOMES AND PAYOUTS TO A JACKPOT WAGER IN GAMES

(71) Applicant: RAPHAEL MOURAD, THORNHILL (CA)

(72) Inventor: RAPHAEL MOURAD, THORNHILL (CA)

(21) Appl. No.: 17/803,093

(22) Filed: Feb. 4, 2022

Related U.S. Application Data
(63) Continuation-in-part of application No. 16/501,406, filed on Apr. 10, 2019.

(51) Int. Cl. G07F 17/32

(52) U.S. Cl. CPC G07F 17/3258; G07F 17/3267

(57) ABSTRACT

A Jackpot Wager in electronic and table games setups is defined herein as a wager placed in a game that can potentially hit a Jackpot Outcome with a Hit Frequency of less than 10⁻⁵ (1 in 100,000 which is equivalent to 0.001%), and when hit, it pays a jackpot payout of at least 100,000 to 1. As defined, such Jackpot Wagers are rarely found nowadays in both electronic and particularly in table games setups in gambling establishments, and when found they are then associated with constant pre-determined Jackpot and Winning Outcomes and constant respective payouts. In addition, the current implementation of the Jackpot Wager in table games setups as a side wager to a table main game affects badly the simplicity, fairness and integrity of the whole game. This invention discloses variable Jackpot Outcomes selected by a participant and variable Winning Outcomes and respective payouts established by an Assessment, Management and Storing System, AMSS, to a Jackpot Wager in electronic games setups. The disclosure also discloses variable Jackpot and Winning Outcomes and variable respective payouts to a Jackpot Wager in table games setups as a side wager being established by the AMSS to a table main game without affecting the simplicity, fairness and integrity of the whole game.

### FIELD OF THE INVENTION

This invention relates to variable Jackpot and Winning Outcomes and respective payouts to a Jackpot Wager placed by a participant in a game associated with a plurality of Jackpot Outcomes, having each a Hit Frequency, HF, of less than 10⁻⁵. Before a round of the game starts, one of the many Jackpot Outcomes (Instant Jackpot Outcome, IJO) and other Winning Outcomes, WO's, with their respective payouts are displayed and become in effect. The game outcome is then compared to the displayed IJO and WO's, and the Jackpot Wager is settled accordingly. If the game outcome matches exactly the IJO, the participant gets paid at least 100000 to 1 in accordance to the displayed IJO payout and if the outcome matches any of the WO's, the participant gets paid according to the displayed WO's payouts.

### BRIEF DESCRIPTION OF THE DRAWINGS

So the those having ordinary skill in the art to which the present disclosure pertains will more readily understand how to make and use the subject invention, exemplary embodiments will be described in detail herein below with reference to the drawings, wherein:

FIG. 1 is a Table showing the minimum number of entities, Nm, that would render the Hit Frequency of any combination or permutation of W entities out of Nm to be less than 10⁻⁵

FIG. 2 is a Table showing the minimum number of entities, Nm, that would render the Hit Frequency of any combination or permutation of W entities to be less than 10⁻⁶

FIG. 3 is giving winning outcomes and their respective payouts to a Jackpot Wager for a selected combination of 5 numbers out of a single set of 39 numbers.

FIG. 4 is giving winning outcomes and their respective payouts to a Jackpot Wager for a selected permutation of 4 letters out of multiple sets, each set consists of the 26 alphabetic letters.

FIG. 5 is giving winning outcomes and their respective payouts to a Jackpot Wager for a selected combination of 4 cards out of a single set of the 52 standard playing cards.

FIG. 6 is giving winning permutations of 5 symbols and their respective payouts to a Jackpot Wager for a selected symbol (character) out of multiple sets, each set consists of 15 symbols.

FIG. 7, 7A, 7B give IJO's and WO's as combinations of 4 cards out of multiple sets of the standard 52 playing cards and respective payouts to a Jackpot (side) wager “NINES”/“SEVENS” in Baccarat.

FIGS. 8, 8A and 8B give IJO's and WO's of W combinations out of multiple sets of the standard 52 playing cards and their respective payouts to a Jackpot (side) wager “PLAYER 2021”, “FIVES” and “SEVENS” respectively in Blackjack.

FIGS. 9, 9A and 9B give IJO's and WO's of W combinations out of multiple sets of the standard 52 playing cards and their respective payouts to a Jackpot (side) wager “HOUSE 2021”. “FIVES” and “SEVENS” respectively in Blackjack.

### BACKGROUND ART AND SUMMARY OF THE PRESENT DISCLOSURE

A wide variety of games are known in the gaming industry, including social games and games played at casinos. In general, games at casinos are divided into two main categories; slot/video machines and table games. Most of the slot/video machines offer games of pure chance, while table games offer games of pure chance and games with a skill component.

Since slot/video machines are designed and built using computers and data processors that can handle a very large number of symbols and data and can process a very large number of possible outcomes, say between 10,000 and 1,000,000, and as such, payouts on unique winning combinations or permutations of the said symbols could be very high. Games played in slot machines, that mostly use and display symbols or characters, could therefore have large jackpot payouts that could reach hundreds of thousands to one, Mega Jackpot. The use of a large number of symbols or characters on each reel, associated with variable frequencies of their display, allows the designer of slot/video machines to achieve constant Jackpot Outcomes and payouts associated with a very low Hit Frequency, HF. However, the majority of the current slot/video machines are designed with a higher HF and smaller payouts of 10 to 1 (mini Jackpot), 25 to 1 (Minor Jackpot), 100 to 1 (Major Jackpot) and 1000 to 1, (Grand Jackpot).

Games played in table games setups, however, could be games of pure chance (such as craps, Roulette, Casino war, Big Wheel and Baccarat) or games with a skill component (such as BlackJack and Poker-type games). Since these games are not using any computers or data processors, the number of possible and manageable outcomes in these games must be very limited, say between 10 and 100, and as such payouts are limited to low values. Winners in these games are paid one to one (even money) on the main wager placed by game participants, such as in Casino War, and in the most popular games Blackjack and Baccarat. Higher payouts, up to tens to one on the main wager are also available on other table games, (such as Roulette, Craps, Big Wheel, and poker-type games) and on side bets on these table games, (such as Match the Dealer, Perfect Pairs, Lucky Ladies, Dragon Bonus and Pairs). Since the number of possible outcomes or combinations in these games is relatively small, payouts on winning combinations are relatively small, say up to one hundred to one. Jackpot-like payouts, ten thousand to one million to 1, are very hard to implement in a table game setup. The current Jackpot-like payouts are limited to constant Jackpot Outcomes and they often affect the simplicity, fairness and integrity of the game.

A Jackpot Wager in electronic and table games setups is defined herein as a wager placed in a game that can potentially hit a Jackpot Outcome with a Hit Frequency of less than 10⁻⁵ (1 in 100,000 which is equivalent to 0.001%), and when hit, it pays a payout of at least 100,000 to 1.

The design and technology used in slot/video machines are quite different from those used in table games setups. The design and technology of slot machines have changed a lot over the years. The classic mechanical designs have been almost completely replaced by computer-controlled machines. Initially, the player pulled a handle to rotate a series of reels that have entities printed on them. These entities include popular symbols currently used in said machines, such as 10 to ace, club, diamond, heart, spade of the standard playing cards; blank, lucky color number 7 or multiple 7's, liberty bell, bar or stack of bars, fruits, and characters such as pictures and icons. The number of the entities (symbols or characters) printed on each reel of the machine varies among the different designs but typically it is 10 to 20. Winning on or losing of a placed wager is determined by which entities line up with the pay line. The payout depends on which entity land on each reel along the pay line, and a jackpot-like payout will happen only if a specific pre-determined entity will display on all the reels all along the pay line. Video slots operate the same way as regular machines, but they have a video image rather than actual rotating reels.

As an example, a machine that has 5 reels and 10 entities on each reel, a unique jackpot symbol has to line up along all the 5 reels to hit the jackpot. It would be reasonable, but wrong, to assume that since 10 to the power of 5 equals 100,000, a player's chance of hitting the jackpot is one in 100,000. It is wrong, since a slot machine is designed for many more stops or display than the 10 symbols visible on the reel, something like 32, 64, 128, 256, 512, 1024 or more stops on each reel. The control mechanism used to determine which entities would display on a reel was initially mechanical using elaborate configuration of gears and levers, then electro mechanical using chips, lights and photoelectric cells. Most modern slot machines are designed to look and feel like the old mechanical models, but they work on a completely different principle. The outcome of each pull or the press of the spin button is actually controlled by a central computer inside the machine, not by the motion of the reels. A Random Number Generator, RNG, at the heart of the computer ensures that each pull or spin button has equal shot at hitting the jackpot, and the chances to hit the jackpot are much less than one in 100,000.

Whenever the slot machine is turned on, the RNG is spitting out whole numbers (typically between 1 and a billion) hundreds of times a second. The computer, in a machine with R reels, selects and records R numbers from the RNG, then it feeds these numbers through a simple program to determine where the reels should stop, i.e. which entity would display on each of the R reels.
The computer divides each of the R random number by a set value, typically 32, 64, 128, 256, 512 or 1024, and records the remainder of the R quotients. Obviously, these quotients are 0 up to the value of the (divider−1). These quotients correspond to the entities on the reel and determine where each reel will stop and which entity will display on the pay line.

For example, in a machine with 4 reels, 10 entities on each reel and the divider is 32, the numbers 1 through 8 might correspond to a blank, 9 through 16 to a lemon, 17 through 24 for a single bar, and so on. Obviously, more numbers correspond to lower paying symbols than higher paying ones. If only one number, say 0, corresponds to the jackpot entity, and if all of the reels are set up the same way, this means that since the chance of hitting the jackpot entity on one reel is 1 in 32, then the chances of hitting the jackpot (hitting the jackpot entity on all the 4 reels) is 1 in 32⁴, or 1,048,576, a Hit Frequency of less than 1 in a million.

The current disclosure uses the simplest design configuration of slot/video machines. When N entities are used on each reel, the selection and display of each of the N entities is purely and equally random; the RNG divider is also N, and each quotient (0 to N−1) corresponds to a single entity providing each entity equal chance to be selected and displayed.

In the simulation of the above example of 4 reels and 10 entities machine, as described at the end of paragraph [015], to a table game setup, when physical entities (cards or tiles) are used and when Random Number Generators and data processors are not used, one must use 4 sets, each set consisting of 32 cards (or tiles), whereas each card is bearing one of these 10 symbols within the said distribution of the symbols as in paragraph [016], and randomly withdrawing one card (or tile) from each of these 4 sets to form an outcome of 4 cards (or tile). Such an endeavor is impractical and unmanageable.

This invention discloses wagers on games being implemented on slot/video machine and table game setups, and side wagers on existing table games, associated with a plurality of Jackpot Outcomes having each a Hit Frequency of less than 0.001% (0.00001), one of which (the IJO) is displayed and become in effect before a round of game starts. In addition, WO's and their respective payouts associated with the IJO are displayed. When the outcome of the game matches the IJO, the participant in the game who placed the Jackpot Wager gets paid at least one hundred thousand to one. If the outcome matches any of the WO's, then the participant is paid the respective WO's payouts. The advantageous of the present disclosure is to provide variable jackpot-like outcomes and payouts to a jackpot wager, without impacting the simplicity, fairness, honesty and integrity of the wagering game. Payouts as provided in the exemplary embodiments or in the drawings are just examples that establish a positive, reasonable and fair edge or advantage to the gaming establishment. The applicant is aware that the actual payouts and edges will have to go through scrutiny and approval by the local regulatory and licensing authorities. Exemplary embodiments in electronic games setups are described below.

### Preferred Embodiments of the Present Disclosure for Electronic Games Setups

The game may use a single or multiple sets, each set constitutes of N entities, and each entity represents one of M defined symbols or characters. Examples of these sets is the 52 standard playing cards (N=M=52), the 26 alphabetic letters (N=M=26), the numbers 1 to N (M=N) or any other sets of N entities bearing M different symbols or characters (M<=N).

When a single or multiple sets of N entities are used in a game, all the possible outcomes (random combinations or permutations) of W entities (W=2, 3, 4, . . . ) are rated within a descending ranking system of categories from low to high Hit Frequency and compiled within an Assessment, Management and Storing System, AMSS. All the outcomes with Hit Frequencies less than 10⁻⁵ are ranked within a category labeled High Ranking Outcomes, HRO's. Before a round of the game starts, one of the many HRO (an Instant Jackpot Outcome, IJO) and other Winning Outcomes, WO's, with their respective payouts, associated with the value of W are selected, displayed and become in effect. The game outcome is then compared to the displayed W, IJO and WO's, and the Jackpot Wager is settled accordingly. If the game outcome of W entities matches exactly the IJO, the participant gets paid at least 100000 to 1 in accordance to the displayed IJO payout and if the outcome of W entities matches any of the WO's, the participant gets paid according to the displayed WO's payouts.

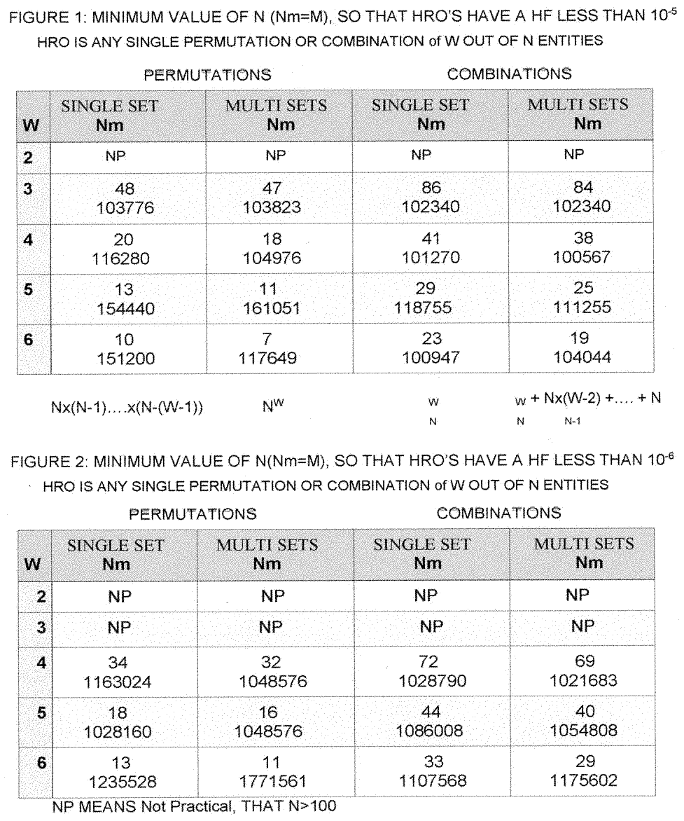

The selection of W, the IJO and other WO's is mostly executed randomly by the AMSS. In a game with a pre-determined value of W and If all the possible outcomes of W entities are HRO's at every round of play, then the selection of the IJO can be done by the participant. If so, the AMSS checks the validity of the participant's selection of the IJO and if confirmed, the AMSS displays the number W, the IJO and the WO's with their respective payouts. FIGS. 1 and 2 are tables showing for a specific value of W (W=2, 3, 4, 5, 6), the minimum value of N, (Nm=M), so that any combination or permutation of W entities out of Nm would be a HRO i.e. would have a HF less than 10⁻⁵ and 10⁻¹ respectively. According to these tables, any combination of five entities, W=5, would have a HF less than 10⁻⁵, when a single set consisting of at least 29 entities is used. As another example, any permutation of four entities, W=4, would have a HF less than 10⁻⁶, when multi sets, each set consisting of at least 32 entities, are used.

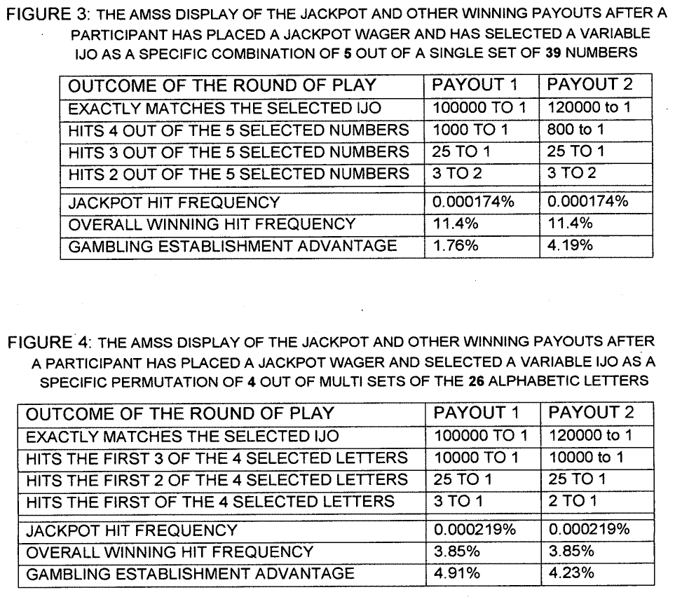

A slot/video machine designed according to paragraph [022] and FIG. 1, Nm=29, which has 5 reels where each reel can display one or more entities out of a single set of 39 numbers, say 1 to 39, would allow a participant in the game to select any combination of 5 numbers out the 39 numbers to be the (variable) IJO in a round of the game. Winning payouts in each Found of the game would be displayed by the AMSS and could be as those given in FIG. 3.

A slot/video machine designed according to paragraph [022] and FIG. 1, Nm=18, which has 4 reels, each reel can display one or more entities out of a multi sets of the 26 alphabetic letters, A to Z, would allow a participant in the game to select any permutation of 4 letters to be the (variable) IJO in a round of the game. Winning payouts in each round of the game would be displayed by the AMSS and could be as those given in FIG. 4.

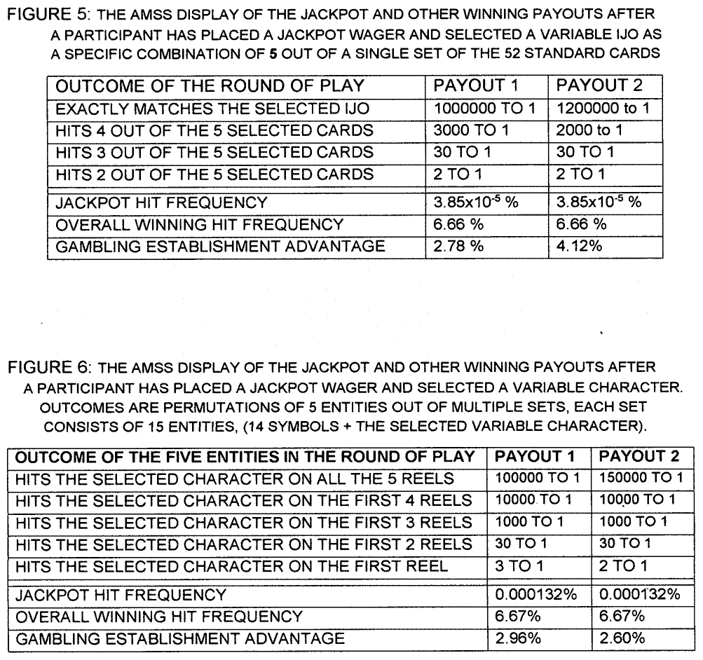

A slot/video machine designed according to paragraph [022] and FIG. 2, Nm=44, which has 5 reels where each reel can display one or more entities out of a single set of 52 entities, each entity bearing one of the 52 standard card deck, would allow a participant in the game to select any combination of 5 entities out the 52 cards to be the (variable) IJO in a round of the game. Winning payouts in each round of the game would be displayed by the AMSS and could be as those given in FIG. 5.

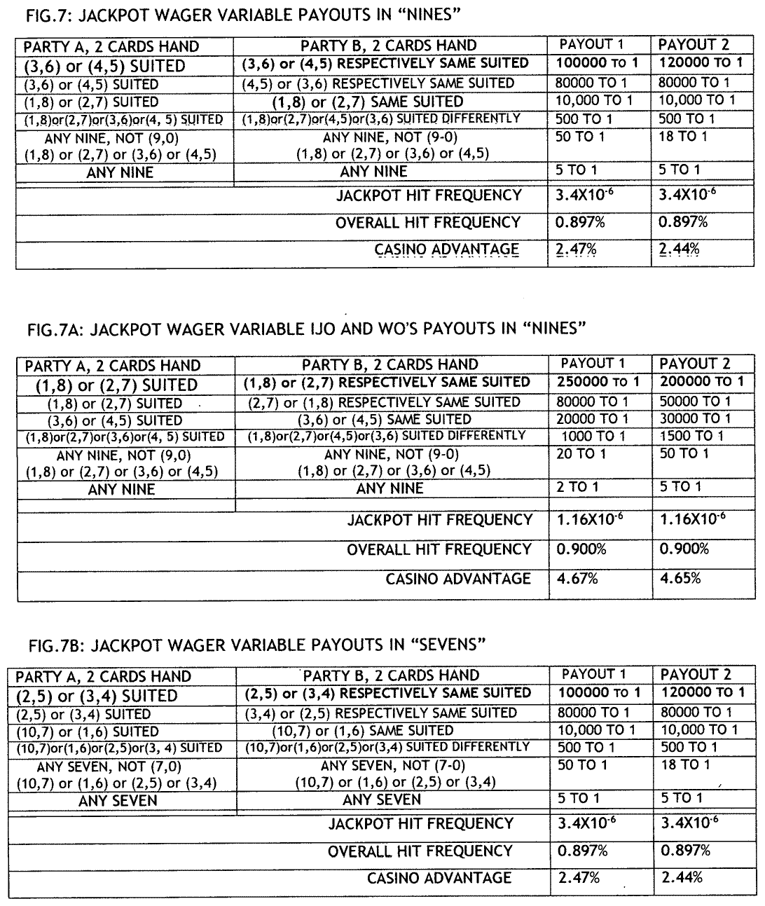

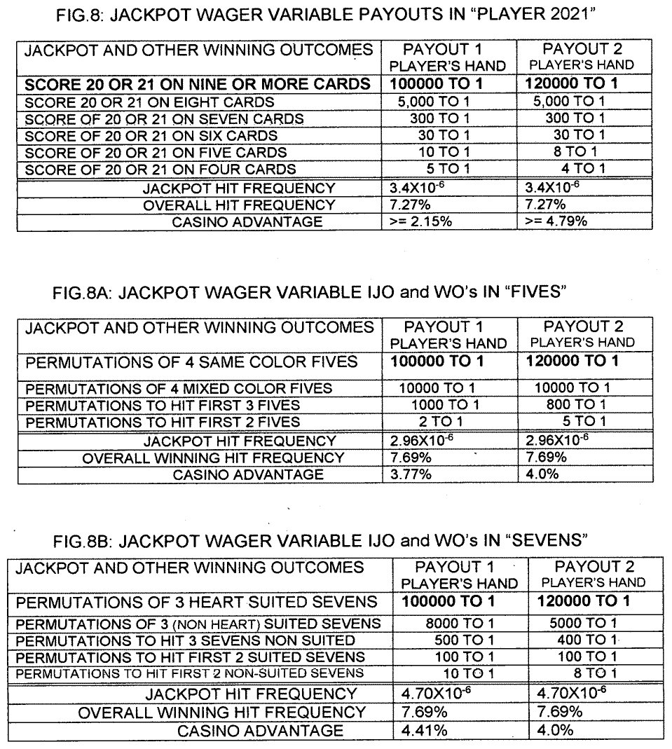

A slot/video machine designed according to paragraph [022] and FIG. 1, Nm=11, which has 5 reels where each reel can display one or more entities out of a multi sets of 15 entities each, each entity bearing one of 14 pre-determined popular symbols and one character selected by a participant, to be the (variable) character to represent the jackpot symbol in a round of the game. The IJO would be the permutation of the selected character on all the 5 reels of the slot/video machine. The selected character and the jackpot and all the other winning payouts in each round of the game would be displayed by the AMSS and could be as those given in FIG. 6.

However, in a game with a variable value of W or if all the possible outcomes of a fixed value of W entities do not have the same HF, or are having different Hit Frequencies at consecutive rounds of play, then the assessment and the selection of W, the IJO and the WO's can be done only by the AMSS. If so, then the AMSS displays W, the IJO and the WO's and their respective payouts before a round of play starts. Such a situation can happen in table games setups whereas the game starts with a new shoe containing a single or multiple sets, each set consists of N entities in a random order, the withdrawal of multiple entities from the shoe at each round of play, and the use of the remaining shoe in the next round of play. As a result, the content IJO the shoe varies with time, causing changes in W, the HRO's and consequently changes in the IJO and WO's and their payouts. In such a situation, the implementation of variable parameters is essential, since the use of constant parameters in the game could badly affect the fairness and integrity of the game. In such a situation, and before a new round of play starts, the AMSS assesses the HF of each outcome out of the remaining shoe, determines the HRO's, selects the IJO and displays the value of W, the IJO and the WO's with their respective payouts without affecting the fairness, simplicity and integrity of the whole game. Exemplary embodiments in table games setups are described below.

### Preferred Embodiments of the Present Disclosure for Table Games Setups

In an exemplary embodiment of a Jackpot Wager in a game as described in [027], a side wager, “NINES”, associated with the popular game BACCARAT, is described below.

The or each participant in the conventional BACCARAT game who places an initial main wager on one of two parties, PLAYER or BANKER, has the option to place a Jackpot Wager on “NINES” at the start of the game. Initially, the BACCARAT game uses a shoe containing a plurality (6 to 10) decks of the 52 standard cards, and two cards are exposed to “PLAYER” and two cards are exposed to “BANKER” randomly from the cards shoe. The BACCARAT Scoring System is used; each of the spot cards from 2 to 9 having a value equal to the number of the corresponding spot card, each ace having a value of one, and each of the tens, jacks, queens and kings having a value of zero, a total score of two or more cards being the last digit of the sum of the values of the cards. Using the said BACCARAT scoring system, the score of each party toward hand is therefore between 0 and 9. The AMSS evaluates the HF of any two pairs, having the same score, as it determines that any two same suited pairs have a HF of 0.00000785, i.e. less than 10⁻⁵, and as such, any of these two pairs form an HRO. An IJO of same suited two pairs (W=4) whereas each pair score value is 9 such as (3,6) & (4,5) or (1,8) & (2,7) or (3,6) & (1,8), or a combination of, along with the WO's and their respective payouts are being displayed by the AMSS and become in effect. If the outcome of the game matches exactly the IJO, the Jackpot Wager on “NINES” gets paid the displayed Jackpot payout, and if the outcome matches any of the WO's, it gets paid the respective WO payout. FIG. 7 gives an example of a displayed IJO, WO's and two examples of their respective payouts (Payout 1 and Payout 2) when 8 decks of cards are used. The Jackpot HF is 3.4×10⁻⁶ and the Jackpot payout is 100,000 to 1 and 120000 to 1 respectively. The overall hit frequency of the Jackpot Wager is 0.897% and the Casino Advantage, CA, is 2.47% and 2.44% respectively.

As noted from FIG. 7, the Jackpot Wager “NINES” wins if both parties hands scores are nines, otherwise it is a loss. If the Jackpot Wager is a win, then the play ends (wagers on “NINES” are paid and the two parties push on the main wager) and a new round starts. If the Jackpot Wager “NINES” is a loss then wagers on “NINES” are collected and the play continues according to the BACCARAT rules to decide on the fate of the main wager. The introduction of the Jackpot wager as a side bet in BACCARAT does not affect the simplicity of the game.

After a few rounds of play, the HF of a constant IJO of 4 entities out of the remaining shoe could be much different than at the initial shoe, as it could be zero, much lower or higher than 0.001%. As a result, the fairness and integrity of the game could be badly affected. Therefore in subsequent rounds of play, the AMSS determines the remaining cards in the shoe, reevaluates the HF of same suited equal value pairs, establishes the HRO's, and randomly selects one these HRO's to be the IJO. Preferably, the IJO would be two same suited pairs, each pair with a score of 9 as given in FIG. 7A. Alternatively, the AMSS could display two same suited pairs with a different score available in the remaining shoe such as “SEVENS” or “EIGHTS” and having a non-zero HF and less than 10⁻⁵, as given in FIG. 7B. The implementation of variable IJO, WO's and their respective payouts is necessary to maintain the fairness, integrity and honesty of the game.

In summary, the incorporation of a Jackpot Wager as a side bet in the BACCARAT game as described in [029], [030] and [031] is providing a variable Jackpot payout of at least 100,000 to 1, and other variable Winning Outcomes and respective payouts without affecting the simplicity (to play, to deal and to manage) and the fairness/integrity (honesty, card counting) of the game.

In another exemplary embodiment of a Jackpot Wager in a game as described in [027], a side wager, “PLAYER 2021”, associated with the most popular game in the world, BLACKJACK, is described below.

The or each participant who placed an initial main bet to play BlackJack against the House, may also place an optional Jackpot Wager on “PLAYER 2021” at the start of the game. Initially, the BLACKJACK game uses a shoe containing a plurality (2 to 10) decks of the 52 standard cards, each deck comprising of the 52 standard playing cards and of four suites of cards, including spot cards with numbers from ace to ten, jacks, queens and kings. The BLACKJACK Scoring System is used; each of the spot cards from 2 to 10 having a value equal to the number of the corresponding spot card, each of the jacks, queens and kings having a value of ten, and each of the aces having a value of one or eleven, a total score of two or more cards being a sum of the values of the cards. The or each participant is randomly dealt two cards face up and the House is dealt one card face up and one card face down from the cards shoe. The or each participant may choose to stand pat, to split two equal value cards or to withdraw additional cards, all at the participant personal strategy and decision but within the rules and restrictions of the BlackJack game. Player's hand is a loss if the score of the cards in the hand is more than 21. The AMSS in evaluating the HF of every W cards having a score of 20 or 21, determines that when 8 decks of cards are used, any hand of 9 or more cards with a score of 20 or 21 would have a HF of less than 0.0000034, and therefore form an HRO. The AMSS establishes therefore that all the combinations of 9 or more cards with a score of 20 or 21 would be in the HRO category and any one of them could be the IJO. FIG. 8 gives an example of a displayed IJO, WO's and two examples of the respective payouts when 8 decks of cards are used. The Jackpot HF is 3.4×10⁶ and the overall Jackpot Wager winning HF is 7.27%. When the size of the Jackpot wager is limited to the size of the main wager, 8 decks of cards are used, and participants can't withdraw additional cards on a hand that achieved the score of 20 or 21. The combined Casino Advantage on the main and Jackpot wagers with the given Jackpot and other winning payouts as given in FIG. 8 for the two payouts is at least 2.15% and 4.79% respectively.

As noted from FIG. 8 the Jackpot Wager on “PLAYER 2021” pays if the player's hand achieves a score of 20 or 21 with at least 4 cards, with higher payouts when the score is achieved with a larger number of cards. After the Jackpot wager is settled, the play then continues according to the Blackjack rules to decide on the fate of the main wager. The introduction of the Jackpot wager as a side bet in Blackjack does not affect the simplicity of the game.

After a few rounds of play, the HF of a constant IJO out of the remaining shoe could be much different than at the initial shoe, as it could be zero, much lower or higher than 0.001%. As a result, the fairness and integrity of the game could be badly affected. Therefore in subsequent rounds of play, the AMSS determines the remaining cards in the shoe, reevaluates the HF of permutations of W entities, establishes the HRO's and related values of W, and randomly selects one these HRO's to be the IJO. Preferably, the IJO would be the same as before, 9 cards with a score of 20 or 21 as given in FIG. 8. Alternatively, the AMSS could display as an IJO, 4 same color fives with a score of 20 “FIVES” or 3 heart suited cards with a total score of 21, “SEVENS”, as having a non-zero HF and less than 10⁻⁵, as given in FIGS. 8A and 8B. In FIG. 8A, the Jackpot HF is 2.96×10⁻⁶ and the overall Jackpot Wager winning HF is 7.69%. In FIG. 8B, the Jackpot HF is 4.70×10⁻⁶ and the overall Jackpot Wager winning HF is 7.69%. The Casino Advantage for all the payouts given in FIGS. 8A and 8B is 3.7 and 4.4%. The implementation of variable IJO, WO's and their respective payouts is necessary to maintain the fairness, integrity and honesty of the game.

In summary, the incorporation of the Jackpot Wager “PLAYER 2021” or “SEVENS” or “FIVES” in the BLACKJACK game is providing Jackpot-like payouts of at least 100,000 to 1, without affecting the simplicity (to play, to deal and to manage) and the integrity (honesty, card counting) of the whole game.

In another exemplary embodiment of a Jackpot Wager in a game as described in [027], a side wager, “HOUSE 2021”, associated with the most popular game in the world, BLACKJACK, is described below.

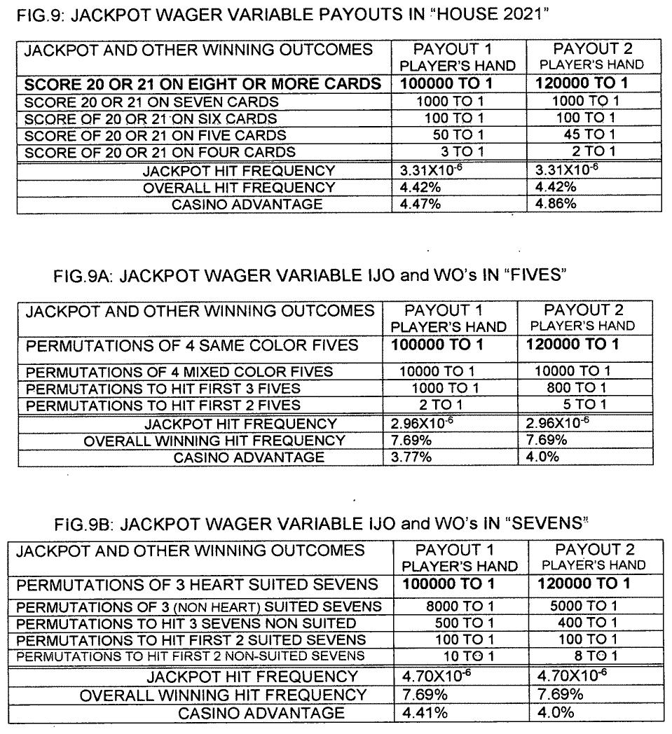

The or each participant who placed an initial main bet to play BlackJack against the House, may also place an optional Jackpot Wager on “HOUSE 2021” at the start of the game. Initially, the BLACKJACK game uses a shoe containing a plurality (2 to 10) decks of the 52 standard cards, each deck comprising of the 52 standard playing cards and of four suites of cards, including spot cards with numbers from ace to ten, jacks, queens and kings. The BLACKJACK Scoring System is used; each of the spot cards from 2 to 10 having a value equal to the number of the corresponding spot card, each of the jacks, queens and kings having a value of ten, and each of the aces having a value of one or eleven, a total score of two or more cards being a sum of the values of the cards. The or each participant is randomly dealt two cards face up and the House is dealt one card face up and one card face down from the cards shoe. The or each participant may choose to stand pat, to split two equal value cards or to withdraw additional cards, all at the participant personal strategy and decision but within the rules and restrictions of the BlackJack game. Player's hand is a loss if the score of the cards in the hand is more than 21. After the players have acted, the House exposes the face down card, stands or withdraw additional cards in accordance to the HOUSE rules in BlackJack i.e. stands when the House hand has a score between 17 and 21 or breaks (more than 21). The AMSS in evaluating the HF of every W cards having a score of 20 or 21, determines that when 8 decks of cards are used, any House hand of 8 or more cards with a score of 20 or 21 would have a HF of less than 0.0000034, and therefore form an HRO. The AMSS establishes therefore that all the combinations of 8 or more cards with a score of 20 or 21 would be in the HRO category and any one of them could be the IJO. FIG. 9 gives an example of a displayed IJO, WO's and two examples of their respective payouts when 8 decks of cards are used. The Jackpot HF is 3.31×10⁻⁶ and the overall Jackpot Wager winning HF is 4.42% and the casino advantage on the Jackpot wager for the 2 payouts given in FIG. 9 is 4.47% and 4.86% respectively.

As noted from FIG. 9 the Jackpot Wager on “HOUSE 2021” pays if the House hand achieves a score of 20 or 21 with at least 4 cards, with higher payouts when the score is achieved with a larger number of cards, After the main and Jackpot wagers are settled, the play then ends and a new round of play starts. The introduction of the Jackpot wager “HOUSE 2021” as a side bet in Blackjack does not affect the simplicity of the game.

After a few rounds of play, the HF of a constant IJO out of the remaining shoe could be much different than at the beginning shoe, as it could be zero, much lower or higher than 0.001%. As a result, the fairness and integrity of the game could be badly affected. Therefore in subsequent rounds of play, the AMSS determines the remaining cards in the shoe, reevaluates the HF of permutations of W entities, establishes the HRO's and related values of W, and randomly selects one these HRO's to be the IJO. Preferably, the IJO would be the same as before, 8 cards with a score of 20 or 21 as given in FIG. 9. Alternatively, the AMSS could display 4 same score cards with a score of 20 “FIVES”, or 3 same score suited cards with a total score of 21 “SEVENS”, as having a non-zero HF and less than 10⁻⁵, as given in FIGS. 9A and 9B. The implementation of variable IJO, WO's and their respective payouts is necessary to maintain the fairness, integrity and honesty of the game.

In summary, the incorporation of a Jackpot Wager “HOUSE 2021”, “SEVENS” or “FIVES” in the BLACKJACK game is providing Jackpot-like payouts of at least 100,000 to 1, without affecting the simplicity (to play, to deal and to manage) and the integrity (honesty, card counting) of the whole game.

1. An Assessment, Management and Storing System, AMSS, associated with electronic slot/video machines setups which randomly displays an outcome of W entities on a pay line out of a single or multiple sets of entities, each set constitutes of N entities, each entity represents one of N defined symbols;
Whereas each of these entities has equal chance to be displayed on the pay line, and each outcome is a High Ranking Outcome, HRO, as having a Hit Frequency, HF, of less than 10⁻⁵, i.e. 0.001%;
Whereas a participant, before a round of play starts, places a Jackpot Wager and selects the value of W and a specific outcome out of the HRO's as an Instant Jackpot Outcome, IJO, to become in effect in the round of play;
Whereas the AMSS checks and confirms the validity of the participant selection of W and the IJO, displays them along with other Winning Outcomes, WO's, and their respective payouts, and allows the participant to activate the machine; and
Whereas the AMSS settles the Jackpot Wager by comparing the play outcome with the displayed IJO and WO's; if the play outcome matches exactly the IJO, the participant gets paid at least 100000 to 1 in accordance to the displayed IJO payout and if the outcome matches any of the WO's, the participant gets paid according to the displayed WO's payouts.

2. The system of claim 1 whereas the participant has selected a specific combination of 5 out of a single set of 39 numbers, as the IJO.

3. The system of claim 1 whereas the participant has selected a specific permutation of 4 letters out of multi sets, each set comprises of the 26 alphabetic letters, as the IJO.

4. The system of claim 1 whereas the participant has selected a specific combination of 5 out of a single set of the 52 standard cards, as the IJO.

5. The system of claim 1 whereas the participant has selected a permutation of a specific symbol from multi equal sets, each set comprises of 15 symbols, to display consecutively 5 times all along the pay line, as the IJO.

6. The system of claim 1 whereas the HF of each HRO is less than 10⁻⁶

7. An Assessment, Management and Storing System, AMSS, associated with table games setups that tracks and exposes randomly an outcome of 2 up to W entities to each party of two out of a shoe initially consisting of multi sets of N entities each, each entity represents one of N defined symbols;
Whereas a participant, before a round of play starts, places a Jackpot Wager as a side wager to a main game;
Whereas the AMSS ranks potential outcomes of W entities out of the remaining shoe within a Scoring System into multiple categories, one of which consists of High Ranking Outcomes, HRO's, each HRO has a Hit Frequency, HF, less than 10⁻⁵, i.e. 0.001%;
Whereas the AMSS selects and displays the value of W, one of the HRO's as the Instant Jackpot Outcome, IJO, and other Winning Outcomes, WO's, and their respective payouts to become in effect in the round of play, without affecting the simplicity, fairness and integrity of the whole game. Two entities are dealt to each party of two;
Whereas each party may receive additional entities beyond the first two exposed entities subject to the rules of the main game;
Whereas the AMSS settles the Jackpot Wager by comparing the play outcome with the displayed IJO and WO's; if the game outcome matches exactly the IJO, the participant gets paid at least 100000 to 1 in accordance to the displayed IJO payout and if the outcome matches any of the WO's, the participant gets paid according to the displayed WO's payouts.

8. The system of claim 7 whereas the main game is a conventional card game, the use of multiple sets of decks of cards, each deck comprising of the 52 standard playing cards (N=52) and of four suits of cards, including spot cards with numbers from ace to ten, jacks, queens and kings;
Whereas the Baccarat Scoring System is used; each of the spot cards from 2 to 9 having a value equal to the number of the corresponding spot card, each ace having a value of one, and each of the tens, jacks, queens and kings having a value of zero, a total score of two or more cards being the last digit of the sum of the values of the cards;
Whereas the category HRO consists of two same suited pairs, W=4.

9. The method of claim 8 whereas the two same suited pairs selected by the AMSS as the IJO, are (3&6) or (4&5).

10. The method of claim 8 whereas the two same suited pairs selected by the AMSS as the IJO, are (1&8) or (2&7).

11. The method of claim 8 whereas the two same suited pairs selected by the AMSS as the IJO, are (2&5) or (3&4).

12. The method of claim 7, whereas the game is a conventional card game, the use of a single or multiple sets of decks of cards, each deck comprising of the 52 standard playing cards;
Whereas the BlackJack Scoring System is used; each of the spot cards from 2 to 10 having a value equal to the number of the corresponding spot card, each of the jacks, queens and kings having a value of ten, and each of the aces having a value of one or eleven, a total score being a sum of the values of the cards;
Whereas the outcome is the player's hand in the Blackjack game; and
Whereas the category HRO consists of W cards with a total score of S1 to S2.

13. The method of claim 12 whereas the AMSS has selected the IJO to consist of 9 cards or more with a total score of 20 or 21. W=9, S1=20 and S2=21.

14. The method of claim 12, whereas the AMSS has selected the IJO to consist of 4 same color five spot cards. W=4, S1=S2=20.

15. The method of claim 12, whereas the AMSS has selected the IJO to consist of 3 heart suited seven spot cards. W=3, S1=S2=21

16. The method of claim 7, whereas the main game is a conventional card game, the use of a single or multiple sets of decks of cards, each deck comprising of the 52 standard playing cards;
Whereas the BlackJack Scoring System is used; each of the spot cards from 2 to 10 having a value equal to the number of the corresponding spot card, each of the jacks, queens and kings having a value of ten, and each of the aces having a value of one or eleven, a total score of two or more cards being a sum of the values of the cards;
Whereas the outcome is the House hand in the Blackjack game; and
Whereas the category HRO consists of W cards with a total score of S1 to S2;

17. The method of claim 16 whereas the AMSS has selected the IJO to consist of 8 cards or more with a total score of 20 or 21. W=8, S1=20 and S2=21.

18. The method of claim 16 whereas the AMSS has selected the IJO to consist of 4 same color five spot cards. W=4, S1=S2=20.

19. The method of claim 16, whereas the AMSS has selected the IJO to consist of 3 heart suited seven spot cards. W=3, S1=S2=21
